(19) United States
(12) Patent Application Publication
(10) Pub. No.: US 2013/0309345 A1
(43) Pub. Date: Nov. 21, 2013

(54) CUTTING APPARATUS FOR A GRANULATOR FOR CUTTING GRANULES FROM PLASTICS-MATERIAL STRANDS EMERGING FROM NOZZLES, HAVING A KNIFE ROTOR

(71) Applicants: Stefan Dahlheimer, Kleinostheim (DE); Helmuth Meidhof, Grossostheim (DE); Gino Czerny, Schleswigerstrasse (DE)

(72) Inventors: Stefan Dahlheimer, Kleinostheim (DE); Helmuth Meidhof, Grossostheim (DE); Gino Czerny, Schleswigerstrasse (DE)

(73) Assignee: AUTOMATIK PLASTICS MACHINERY GMBH, Grossostheim (DE)

(21) Appl. No.: 13/877,110

(22) PCT Filed: Sep. 2, 2011
(86) PCT No.: PCT/EP2011/065164

§ 371 Date: Aug. 9, 2013

(30) Foreign Application Priority Data
Oct. 1, 2010 (DE) 10 2010 037 930.1

(51) Int. Cl. B29C 47/00

(52) U.S. Cl. CPC B29C 47/0066
USPC 425/380

(57) ABSTRACT

The invention relates to a cutting apparatus for a granulator for cutting plastics-material strands emerging from nozzles into granules. The cutting apparatus includes a knife rotor which is connected to a drive shaft via an articulation component having a drive part and via a driven part carrying the knife rotor. The drive part is inserted into a spherical head in a matching spherical cap in the drive part. The spherical head passes through by at least one direction axle, about which the spherical head is rotatable in the spherical cap in case of an axial offset of the drive part and the driven part. In this case, an end of the directional axle that emerges from the spherical head is mounted in a groove in the spherical cap and extends transversely to the direction of rotation of the spherical cap such that, in the case of an offset of the drive part with respect to the driven part, the end moves in the groove.

### BACKGROUND

The invention relates to a cutting apparatus for a granulator for cutting granules from plastics-material strands emerging from nozzles, having a knife rotor which is connected to a drive shaft via an articulation component having a drive part and via a driven part carrying the knife rotor.

### SUMMARY

A cutting apparatus of this type is described in DE 103 21 723 A1. In the cutting apparatus illustrated in FIG. 5 of this printed specification, three individual composite parts are required for driving a knife rotor by means of a drive part via a cardanic articulation piece, with force being transmitted via said cardanic articulation piece. In this apparatus, a drive part includes an axle extending perpendicular to the direction of drive which is used to actuate a frame having two axles. The drive force is applied to one axle of said frame, and a second axle thereof, which is perpendicular to said first frame axle, transmits this force to a driven part which latter constitutes the knife carrier for a cutting apparatus. The above described means is therefore relatively complex in design and is used for compensating changes of axial direction which: occur during operation of the cutting apparatus from a drive shaft to the knife rotor, by means of the cardanic articulation piece. The resulting structure is thus relatively complex and its assembly is considerably aggravated by the fact that the individual components are nested into one another.

It is the object of the present invention to provide a cutting apparatus which can likewise use a cardanic articulation component that is characterized by being particularly simple in design. According to the invention, this is accomplished in that the drive part is inserted into a spherical head in a matching spherical cap provided in the driven part and that at least one direction axle runs through said spherical head about which the spherical head located within the spherical cap can be rotated in the case of an axial offset of the drive part with respect to the driven part. The ends of said direction axle that emerge from the spherical head each run in respective grooves which are provided in the spherical cap and extend transversely to the direction of rotation of the driven spherical cap substantially in the direction of the driven part such that, in the case of an offset of the drive part with respect to the driven part, these ends will move in the grooves provided in the driven part.

The fact that the spherical head can be rotated inside a spherical cap and that the drive part is connected to the spherical head and the driven part is connected to the knife rotor results in a structure that fits within a very tight space and can be used to compensate a displacement of the drive part with respect to the driven part according to a cardanic force transmission. Moreover, the resulting structure is of rather compact design.

In this displacement of the drive part with respect to the driven part, in order to accomplish the internal support of the structural components used, the cutting apparatus is advantageously designed such that the ends of the direction axle each project into a sliding block and can be rotated therein, which sliding block can be moved within the groove adapted to it and provided in the spherical cap.

Further advantages, features and potential applications of the present invention may be gathered from the description which follows, in conjunction with the embodiments illustrated in the drawings.

### BRIEF DESCRIPTION OF FIGURES

Throughout the description, the claims and the drawings, those terms and associated reference signs will be used as are notable from the enclosed list of reference signs. In the drawings:

FIG. 1 shows a cross-sectional view of the cutting apparatus;

FIG. 2 shows an exploded perspective view of the individual components of the cutting apparatus of FIG. 1;

FIG. 3 shows a cross-sectional view similar to that of FIG. 1 including a detailed view of the spherical head with a direction axle;

FIG. 4 shows a perspective view of the cutting apparatus of FIG. 1 in its assembled state;

FIG. 5 shows an axial view of the cutting apparatus of FIG. 1;

FIG. 6 shows a sectional view of a spherical head including the knife carrier with two direction axles that are perpendicular to each other, and

FIG. 7 shows an exploded perspective view of the structure of FIG. 6 and its individual components.

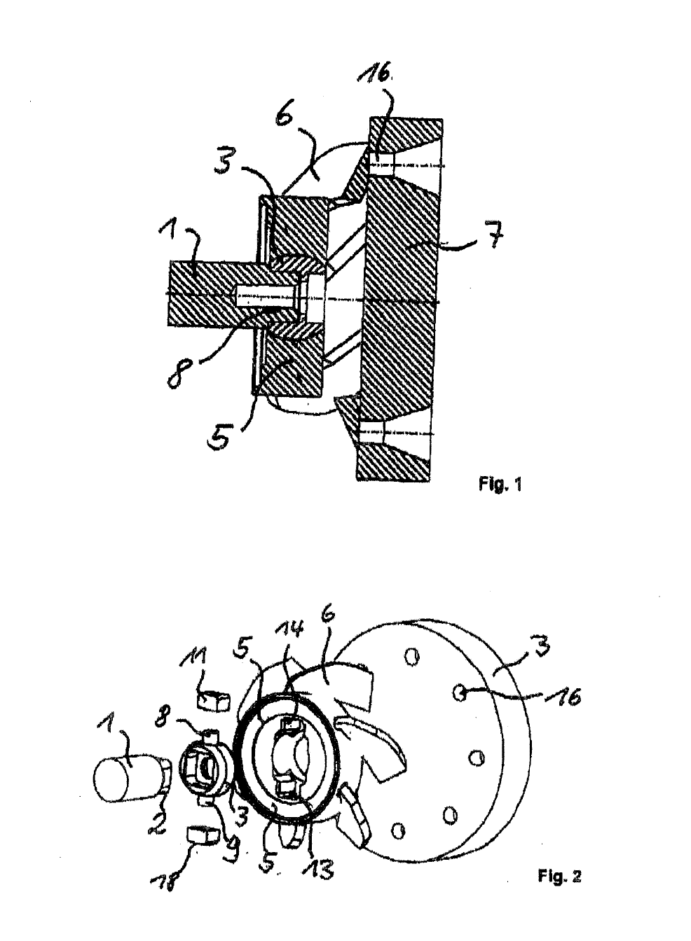

The cutting apparatus shown in cross-sectional view in FIG. 1 includes the drive shaft 1 which directly transitions into the drive part 2. The drive part 2 is mounted within the spherical head 3 and attached to the drive shaft 1 by means of the screw 4. The spherical head 3 is accommodated inside the spherical cap 5 within which the axial direction of the spherical head 3 may be adjusted at will. The spherical cap 5, which constitutes the driven part and has the knives 6 attached to it, forms a knife carrier which is rotated facing the nozzles 16 provided in a nozzle plate 7, thus cutting the strands emerging from the nozzles 16 into granules in a known manner.

In a configuration of this type, it cannot always be ensured that the central axis of the nozzle plate 7 completely coincides with the axial direction of the drive shaft 1. For this reason, the articulated structure shown in FIG. 1 is provided which allows an automatic alignment of the drive shaft 1 with respect to the nozzle plate 7 during operation.

The individual components of the cutting device of FIG. 1 are shown in the exploded perspective view in FIG. 2. As can be seen from FIG. 2, the drive shaft 1 has its drive part 2 extending towards the interior of the spherical head 3. Extending from said spherical head 3 perpendicular to its longitudinal axis are two ends 8 and 9 of a direction axle. These ends 8 and 9 each project into a sliding block 11 and 12, respectively, which latter will be entrained by these ends 8, 9 upon an axial shift of the spherical head 3.

Provided within the spherical cap 5 are grooves 13 and 14 in which the two sliding blocks 11 and 12 run and can be moved in an axial direction of the spherical cap 5.

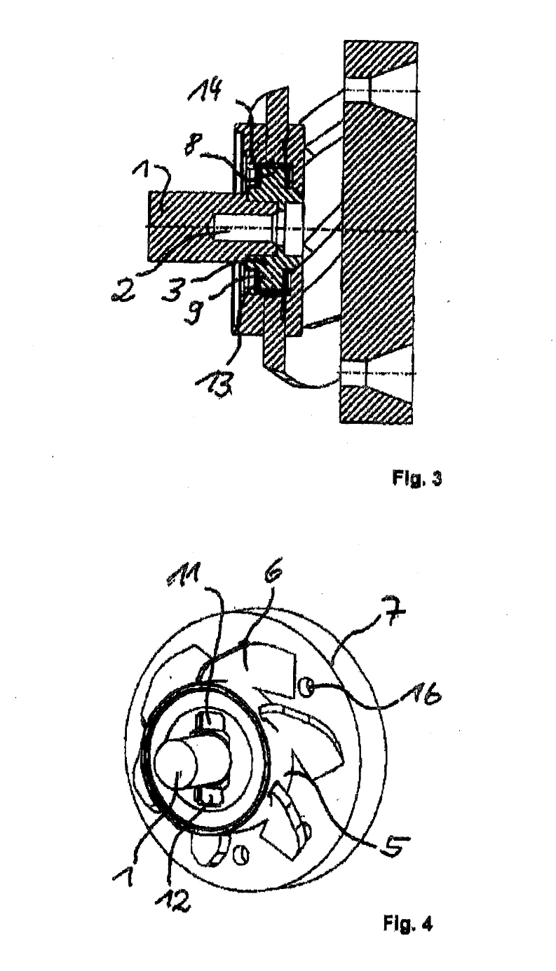

FIG. 3 is a view of the embodiment of FIG. 1 in a different sectional position, with the section extending through the grooves 13 and 14 which each accommodate an axial end 8 and 9 in them and thus enable its movement in the axial direction of the spherical head 3.

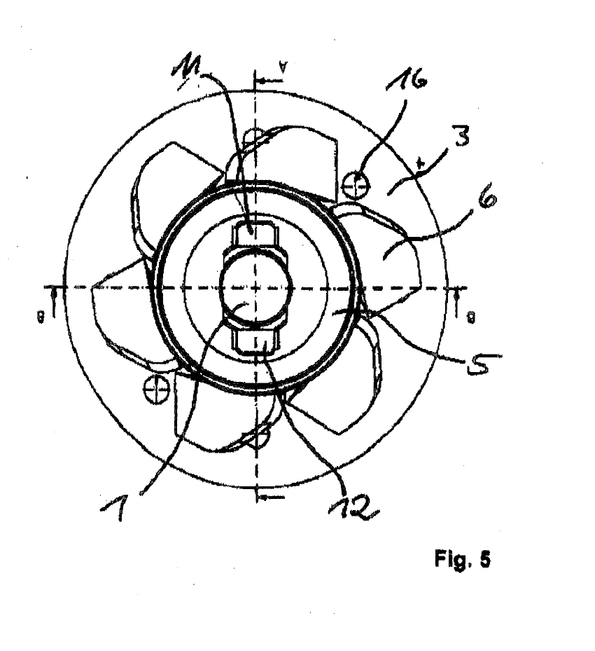

The embodiment of FIG. 3 is shown in perspective view in FIG. 4 which illustrates how the drive shaft 1 engages the spherical cap 5 via the sliding blocks 11 and 12.

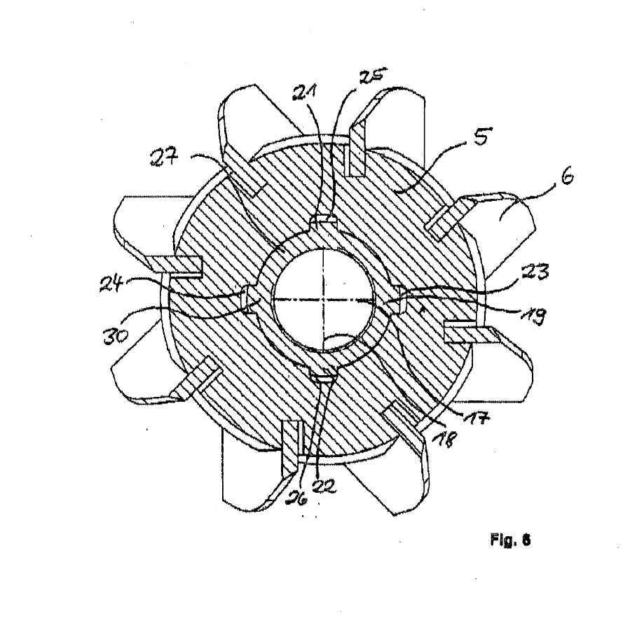

FIG. 5 shows the structure of FIG. 4 with an axial view of the drive shaft 1 which—as set out above—engages the sliding blocks 11, 12 and thus likewise entrains the spherical cap 5. This results in an automatic alignment of the drive shaft 1 and the spherical cap 5 having the knives 6 attached to it.

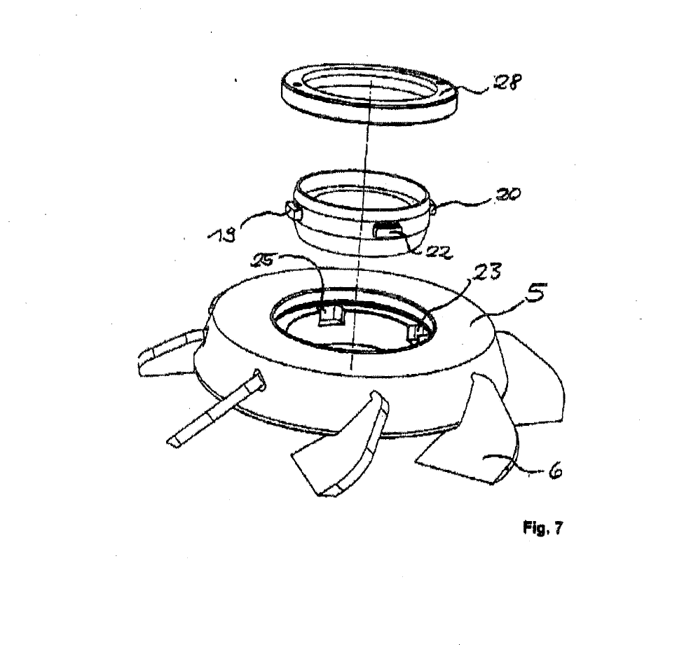

The embodiment shown in FIGS. 6 and 7 illustrates how the spherical cap 5 is entrained by two direction axles 17 and 18 which are perpendicular to each other and extend through the sliding blocks 19-20 and 21-22, respectively. The sliding blocks 19-20 and 21-22 move within longitudinal grooves 23-24 and 25-26 provided in the spherical cap 5. This allows the drive force acting on the spherical head 27 to be transmitted to the spherical cap 5 even when there is a shift in the axial direction.

FIG. 7 is an exploded view of the components shown in FIG. 6, as well as of the end piece 28 which holds the spherical head 27 within the spherical cap 5.

The cutting apparatus shown in cross-sectional view in FIG. 1 includes the drive shaft 1 which directly transitions into the drive part 2. The drive part 2 is mounted within the spherical head 3 and attached to the drive shaft 1 by means of the screw 4. The spherical head 3 is accommodated inside the spherical cap 5 within which the axial direction of the spherical head 3 may be adjusted at will. The spherical cap 5, which constitutes the driven part and has the knives 6 attached to it, forms a knife'carrier which is rotated facing the nozzles 16 provided in a nozzle plate 7, thus cutting the strands emerging from the nozzles 16 into granules in a known manner,

In a configuration of this type, it cannot always be ensured that the central axis of the nozzle plate 7 completely coincides with the axial direction of the drive shaft 1. For this reason, the articulated structure shown in FIG. 1 is provided which allows an automatic alignment of the drive shaft 1 with respect to the nozzle plate 7 during operation.

The individual components of the cutting device of FIG. 1 are shown in the exploded perspective view in FIG. 2. As can be seen from FIG. 2, the drive shaft 1 has its drive part 2 extending towards the interior of the spherical head 3. Extending from said spherical head 3 perpendicular to its longitudinal axis are two ends 8 and 9 of a direction axle. These ends 8 and 9 each project into a sliding block 11 and 12, respectively, which latter will be entrained by these ends 8, 9 upon an axial shift of the spherical head 3.

Provided within the spherical cap 5 are grooves 13 and 14 in which the two sliding blocks 11 and 12 run and can be moved in an axial direction of the spherical cap 5.

FIG. 3 is a view of the embodiment of FIG. 1 in a different sectional position, with the section extending through the grooves 13 and 14 which each accommodate an axial end 8 and 9 in them and thus enable its movement in the axial direction of the spherical head 3.

The embodiment of FIG. 3 is shown in perspective view in FIG. 4 which illustrates how the drive shaft 1 engages the spherical cap 5 via the sliding blocks 11 and 12.

FIG. 5 shows the structure of FIG. 4 with an axial view of the drive shaft 1 which as set out above—engages the sliding blocks 11, 12 and thus likewise entrains the spherical cap 5. This results in an automatic alignment of the drive shaft 1 and the spherical cap 5 having the knives 6 attached to it.

The embodiment shown in FIGS. 6 and 7 illustrates how the spherical cap 5 is entrained by two direction axles 17 and 18 which are perpendicular to each other and extend through the sliding blocks 19-20 and 21-22, respectively. The sliding blocks 19-20 and 21-22 move within longitudinal grooves 23-24 and 25-26 provided in the spherical cap 5. This allows the drive force acting on the spherical head 27 to be transmitted to the spherical cap 5 even when there is a shift in the axial direction.

FIG. 7 is an exploded view of the components shown in FIG. 6, as well as of the end piece 28 which holds the spherical head 27 within the spherical cap 5.

1. A cutting apparatus for a granulator for cutting plastic material strands emerging from nozzles in a nozzle plate, comprising a knife rotor which is connected to a drive shaft via a joint piece having a drive part and a driven part carrying the knife rotor, wherein the drive part is inserted in a head in a matching cap in the driven part and at least one direction axle extends through the head about which the cap is configured to be rotated in case of an axial offset of the drive part with respect to the driven part, with an end of the direction axle that emerges from the head being in a groove provided in the cap and extending transversely to the direction of rotation of the cap such that, when the drive part is offset with respect to the driven part, the end will move within the groove.

2. The cutting apparatus of claim 1, wherein said end the direction axle projects into a sliding block and is configured to be rotated therein, wherein the sliding block is configured to be moved in the groove and provided in the cap.

3. The cutting apparatus of claim 1, wherein said end extending transversely to the direction of rotation of the cap is substantially in the direction of the drive part.

4. The cutting apparatus of claim 1, wherein the head comprises a spherical head and the matching cap comprises a matching spherical cap.

5. The cutting apparatus of claim 1, wherein the cutting apparatus is provided to allow an automatic alignment of the drive shaft with respect to the nozzle plate during operation of the cutting apparatus.
